(19) United States
(12) Patent Application Publication
(10) Pub. No.: US 2024/0187987 A1
(43) Pub. Date: Jun. 6, 2024

(54) COMMUNICATION DEVICE

(71) Applicant: HITACHI ASTEMO, LTD., Hitachinaka-shi, Ibaraki (JP)

(72) Inventor: Ryo FUKUDA, Chiyoda-ku, Tokyo (JP)

(73) Assignee: HITACHI ASTEMO, LTD., Hitachinaka-shi, Ibaraki (JP)

(21) Appl. No.: 18/552,559

(22) PCT Filed: Mar. 1, 2022
(86) PCT No.: PCT/JP2022/008682

§ 371 Date: Sep. 26, 2023

(30) Foreign Application Priority Data
Sep. 27, 2021 (JP) 2021-157188

(51) Int. Cl. H04W 52/02; H04L 67/12

(52) U.S. Cl. CPC H04W 52/0225; H04L 67/12

(57) ABSTRACT

An object is to provide a communication device capable of appropriately storing communication information for specifying another device that performs communication at an abnormal timing. A communication device 10 is a communication device that is mounted on a vehicle and communicates with other devices. The communication device 10 includes a communication monitoring unit 40 that monitors communication with another device and accumulates communication information for specifying another device that performs communication, a storage medium 30 that stores the communication information, and a timer 22 that counts a duration of a wake-up state of the communication device 10. When the duration of the wake-up state has passed a predetermined time, the communication monitoring unit 40 stores the accumulated communication information in the storage medium 30.

### TECHNICAL FIELD

The present invention relates to a communication device mounted on a vehicle.

### BACKGROUND ART

A communication device mounted on a vehicle originally communicates with another device at a predefined timing. Communication with another device at an abnormal timing that is not defined in advance may cause a serious trouble in the vehicle. In order to analyze a failure occurrence factor, a technique is known in which a communication device monitors communication with another device and stores communication information for specifying the other device performing communication (for example, PTL 1).

When the central gateway of PTL 1 wakes up as the K bus becomes active, the central gateway receives node information from each gateway, and stores all the received node information in a memory bank of a storage unit in time series.

### CITATION LIST

### Patent Literature

PTL 1: JP 2014-88150 A

### SUMMARY OF INVENTION

### Technical Problem

The central gateway of PTL 1 merely stores node information of each gateway at the timing of transition from the sleep state to the wake-up state by communication with each gateway. PTL 1 does not assume a case where, for example, the central gateway cannot transition to the sleep state and continues the wake-up state due to continuous communication from each gateway at an abnormal timing. In some cases, the central gateway of PTL 1 cannot store communication information of another device that performs communication at an abnormal timing.

The present invention has been made in view of the above, and an object thereof is to provide a communication device capable of appropriately storing communication information for specifying another device that performs communication at an abnormal timing.

### Solution to Problem

In order to solve the above problem, a communication device of the present invention is a communication device mounted on a vehicle and configured to communicate with another device, the communication device including: a communication monitoring unit that monitors communication with the other device and accumulates communication information for specifying the other device that performs communication; a storage medium that stores the communication information; and a timer configured to count a duration of a wake-up state of the communication device. The communication monitoring unit stores the accumulated communication information in the storage medium when a duration of the wake-up state has passed a predetermined time.

### Advantageous Effects of Invention

According to the present invention, it is possible to provide a communication device capable of appropriately storing communication information for specifying another device that performs communication at an abnormal timing.

Objects, configurations, and effects besides the above description will be apparent through the explanation on the following embodiments.

### BRIEF DESCRIPTION OF DRAWINGS

FIG. 1 is a block diagram illustrating a functional configuration of a communication device according to a first embodiment.

FIG. 2 is a flowchart of processing performed by the communication device illustrated in FIG. 1.

FIG. 3 is a flowchart of processing performed by a communication device according to the second embodiment.

FIG. 4 is a flowchart of processing performed subsequent to the processing illustrated in FIG. 3.

FIG. 5 is a block diagram illustrating a functional configuration of a communication device according to a third embodiment.

FIG. 6 is a flowchart of processing performed by the communication device according to the third embodiment.

### DESCRIPTION OF EMBODIMENTS

Hereinafter, embodiments of the present invention will be described using the drawings. Configurations denoted by the same reference numerals in the respective embodiments have similar functions in the respective embodiments unless otherwise specified, and thus the description thereof will be omitted.

### First Embodiment

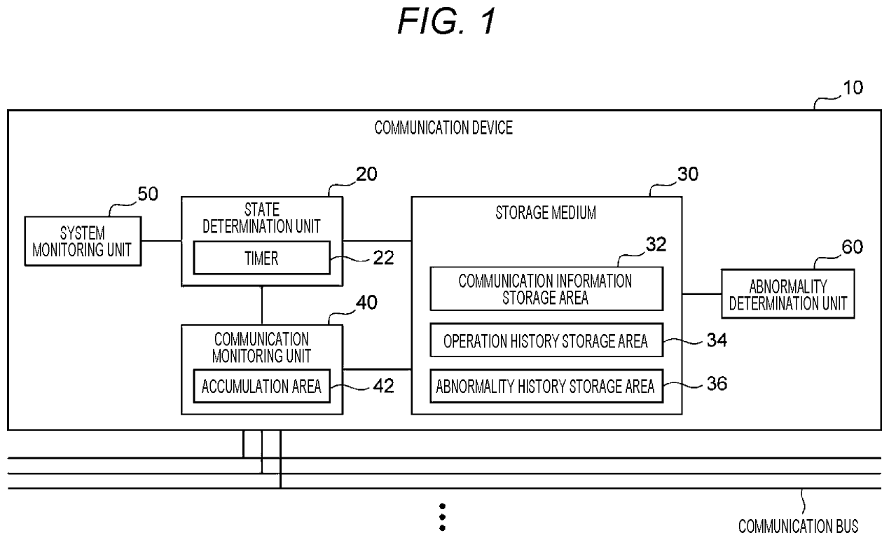

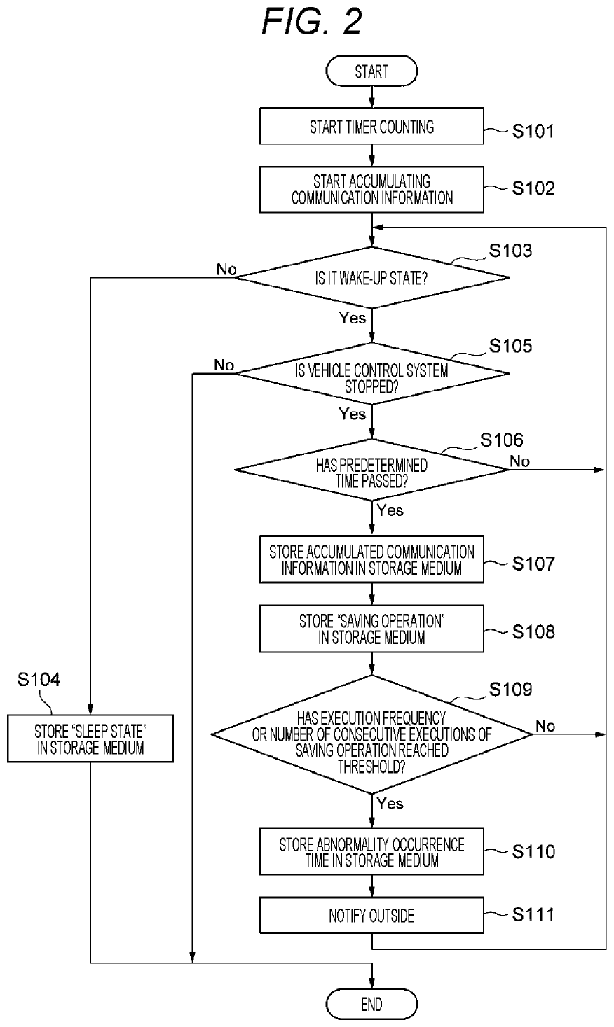

A communication device 10 according to a first embodiment will be described with reference to FIGS. 1 and 2.

FIG. 1 is a block diagram illustrating a functional configuration of the communication device 10 according to the first embodiment.

The communication device 10 is a communication device that is mounted on a vehicle and communicates with other devices. The communication device 10 includes a known microcomputer. The communication device 10 may be, for example, a gateway ECU. The communication device 10 is connected to one or more communication buses to which other devices are connected. The communication device 10 communicates with other devices connected to the communication bus. The communication bus may construct an in-vehicle LAN conforming to one or more communication protocols such as CAN, LIN, or FlexRay. The other devices may be another ECU or another communication device mounted on the vehicle. Note that another device that does not perform communication may be connected to a part of the communication bus, or another device may not be connected.

As illustrated in FIG. 1, the communication device 10 includes a state determination unit 20, a storage medium 30, a communication monitoring unit 40, a system monitoring unit 50, and an abnormality determination unit 60.

The system monitoring unit 50 monitors a state of a vehicle control system mounted on the vehicle. The system monitoring unit 50 determines whether the vehicle control system is in a stopped state or an activated state, and notifies the state determination unit 20 of the determination. The vehicle control system may include, for example, various ECUs that control activation and traveling of the vehicle. The stopped state of the vehicle control system may be, for example, at least one of a state in which an ignition switch is off and a state in which the rotation speed of the engine (or a vehicle driving motor) is zero. The activated state of the vehicle control system may be a state in which the ignition switch is turned on or a state in which the rotation speed of the engine is not zero.

The state determination unit 20 determines whether the communication device 10 is in the wake-up state. That is, the state determination unit 20 determines whether the communication device 10 is in the wake-up state or the sleep state. The sleep state is a state in which the communication function of the communication device 10 is stopped in order to prevent unnecessary power consumption when the vehicle is not used. When the communication device 10 transitions to the sleep state, the state determination unit 20 stores the transition of the communication device 10 to the sleep state in the storage medium 30 as a history of the communication device 10.

The wake-up state is a state in which the communication function of the communication device 10 is activated. The communication device 10 in the sleep state transitions to the wake-up state by communication from the other devices. When communication from the other devices continues, the communication device 10 continues the wake-up state. The state determination unit 20 may determine whether the communication device 10 is in the wake-up state on the basis of the signal level of the communication bus, the presence or absence of a wake-up request from the other devices, the supply voltage to the communication device 10, and the like.

The state determination unit 20 includes a timer 22. The timer 22 clocks the duration of the wake-up state of the communication device 10. That is, the timer 22 counts the time from the transition of the communication device 10 to the wake-up state to the transition to the sleep state. In particular, the timer 22 may count the duration of the wake-up state while the vehicle control system is in the stopped state. When the time counted by the timer 22 reaches a predetermined time, the state determination unit 20 can clear the time counted by the timer 22.

The communication monitoring unit 40 monitors communication with other devices and accumulates communication information for specifying other devices that perform communication. Specifically, the communication monitoring unit 40 monitors communication being performed in the communication bus and acquires communication information. Then, the communication monitoring unit 40 accumulates the acquired communication information in an accumulation area 42. In particular, the communication monitoring unit 40 can monitor communication being performed in the communication bus while the vehicle control system is in a stopped state, and accumulate the acquired communication information in the accumulation area 42.

The communication information is information for specifying another device that performs communication. The communication information includes at least identification information capable of identifying another device that performs communication, and a time stamp indicating a time when the communication device 10 received information transmitted from the other device. When the communication information is accumulated during the stopped state of the vehicle control system, the communication information may further include a time stamp indicating a time at which the system monitoring unit 50 has detected the stopped state of the vehicle control system and a time stamp indicating a time at which the timer 22 has measured a predetermined time described later.

One or more accumulation areas 42 may be provided in the communication monitoring unit 40. The communication monitoring unit 40 may accumulate the acquired communication information by overwriting the communication information in one accumulation area 42. The accumulation area 42 may accumulate the acquired communication information by writing the communication information while switching the plurality of accumulation areas 42.

When the duration of the wake-up state counted by the timer 22 has exceeded a predetermined time, the communication monitoring unit 40 stores the communication information accumulated in the accumulation area 42 in the storage medium 30. In particular, when the duration of the wake-up state has passed a predetermined time while the vehicle control system is in the stopped state, the communication monitoring unit 40 stores the communication information accumulated while the vehicle control system is in the stopped state in the storage medium 30. The predetermined time can be arbitrarily set on the basis of specifications of the communication device 10 and the communication bus. However, this predetermined time is a time (for example, a time in minutes) sufficiently longer than at least the operation cycle of the communication device 10 or the communication cycle of another device. When performing a saving operation of saving the communication information accumulated in the accumulation area 42 in the storage medium 30, the communication monitoring unit 40 saves the fact that the saving operation of the communication information has been performed in the storage medium 30 as a history of the operation of the communication device 10.

The storage medium 30 is a non-volatile storage medium that stores communication information. The communication information stored in the storage medium 30 is used to analyze a failure occurring in the vehicle and an occurrence factor of communication abnormality. The storage medium 30 includes a communication information storage area 32, an operation history storage area 34, and an abnormality history storage area 36.

The communication information storage area 32 is a storage area for storing the communication information accumulated in the communication monitoring unit 40. The operation history storage area 34 is a storage area for storing a history of operations or states of the communication device 10. The operation history storage area 34 stores a history of the saving operation of the communication information by the communication monitoring unit 40 and a history of transition of the communication device 10 to the sleep state. The abnormality history storage area 36 is a storage area for storing a history of occurrence of communication abnormality.

The abnormality determination unit 60 performs abnormality determination to determine whether another device has performed abnormal communication. Specifically, the abnormality determination unit 60 monitors the history saved in the operation history storage area 34, and calculates the execution frequency or the number of consecutive executions of the saving operation by the communication monitoring unit 40. The execution frequency of the saving operation means the number of times the saving operation is performed during a certain period. The abnormality determination unit 60 calculates the execution frequency of the saving operation from the history of the saving operation saved in the operation history storage area 34. The number of consecutive executions of the saving operation means the number of times the saving operation is performed temporally continuously without interposing the sleep state of the communication device 10. The abnormality determination unit 60 calculates the number of consecutive executions of the saving operation from the history of the saving operation and the history of the sleep state stored in the operation history storage area 34.

The abnormality determination unit 60 performs the abnormality determination based on the calculated execution frequency or the calculated number of consecutive executions of the saving operation. Specifically, the abnormality determination unit 60 determines that another device has performed abnormal communication when the calculated execution frequency or the calculated number of consecutive executions of the saving operation reaches a predetermined threshold. The abnormality determination unit 60 determines that another device is not performing abnormal communication when the calculated execution frequency or the calculated number of consecutive executions of the saving operation has not reached the predetermined threshold. This threshold can be arbitrarily set on the basis of specifications of the communication device 10 and the vehicle control system.

When determining that another device has performed abnormal communication, the abnormality determination unit 60 stores, in the abnormality history storage area 36, a time stamp indicating a time at which the execution frequency or the number of consecutive executions of the saving operation has reached a predetermined threshold as an abnormality occurrence time. Then, the abnormality determination unit 60 notifies the occurrence of abnormality to the outside. For example, the abnormality determination unit 60 notifies the vehicle control system of the occurrence of abnormality and notifies the user of the vehicle of the occurrence of the abnormality via the vehicle control system. Note that, depending on the in-vehicle environment of the communication device 10, the abnormality determination unit 60 may not notify the outside of the occurrence of abnormality.

FIG. 2 is a flowchart of processing performed by the communication device 10 illustrated in FIG. 1. When transitioning to the wake-up state, the communication device 10 starts the process illustrated in FIG. 2.

In step S101, the communication device 10 causes the timer 22 to start counting. That is, the timer 22 starts counting the duration of the wake-up state.

In step S102, the communication device 10 monitors communication performed in the communication bus and starts accumulating communication information in the accumulation area 42.

In step S103, the communication device 10 determines whether it is in the wake-up state. In a case where it is determined that the communication device 10 is not in the wake-up state, it is determined that the communication device is in the sleep state, and the process proceeds to step S104. In a case where the communication device 10 determines that it is in the wake-up state, the process proceeds to step S105.

In step S104, the communication device 10 stores the transition of the communication device 10 to the sleep state in the operation history storage area 34 of the storage medium 30. Thereafter, the communication device 10 ends the present processing illustrated in FIG. 2.

In step S105, the communication device 10 determines whether the vehicle control system is in the stopped state. When determining that the vehicle control system is in the stopped state, the communication device 10 proceeds to step S106. When determining that the vehicle control system is not in the stopped state, the communication device 10 determines that the vehicle control system is in the activated state, and ends the present processing illustrated in FIG. 2.

In step S106, the communication device 10 determines whether the time measured by the timer 22 has passed a predetermined time. That is, the communication device 10 determines whether the duration of the wake-up state has passed a predetermined time. In a case of determining that the time measured by the timer 22 has passed the predetermined time, the communication device 10 proceeds to step S107. In a case of determining that the time measured by the timer 22 has not passed the predetermined time, the communication device 10 proceeds to step S103.

In step S107, the communication device 10 stores the communication information accumulated in the accumulation area 42 in the communication information storage area 32 of the storage medium 30.

In step S108, the communication device 10 stores the fact that the saving operation of the communication information has been performed in the operation history storage area 34 of the storage medium 30.

In step S109, the communication device 10 determines whether the execution frequency or the number of consecutive executions of the saving operation has reached the threshold based on the history saved in the operation history storage area 34 of the storage medium 30. When the execution frequency or the number of consecutive executions of the saving operation has reached the threshold, the communication device 10 determines that another device has performed abnormal communication, and proceeds to step S110. When the execution frequency or the number of consecutive executions of the saving operation has not reached the threshold, the communication device 10 determines that another device is not performing abnormal communication. Thereafter, the communication device 10 proceeds to step S103.

In step S110, the communication device 10 stores a time stamp indicating the time at which the determination in step S109 is performed in the abnormality history storage area 36 of the storage medium 30 as the abnormality occurrence time.

In step S111, the communication device 10 notifies the occurrence of abnormality to the outside. Thereafter, the communication device 10 proceeds to step S103.

Note that the communication device 10 may perform the processing by switching the order of step S107 and step S108.

As described above, the communication device 10 according to the first embodiment is a communication device that is mounted on a vehicle and communicates with other devices. The communication device 10 includes a communication monitoring unit 40 that monitors communication with another device and accumulates communication information for specifying another device that performs communication, a storage medium 30 that stores the communication information, and a timer 22 that counts a duration of a wake-up state of the communication device 10. When the duration of the wake-up state has passed a predetermined time, the communication monitoring unit 40 stores the accumulated communication information in the storage medium 30.

As a result, the communication monitoring unit 40 according to the first embodiment can store not only the communication information for specifying other devices that have performed communication at the timing at which the communication device 10 transitions from the sleep state to the wake-up state but also the communication information for specifying other devices that have performed communication while the wake-up state continues in the storage medium 30. For example, when a door of a parked vehicle in which the vehicle control system is in the stopped state is opened, communication is performed from a body control ECU or the like to the communication device 10, so that the communication device 10 transitions from the sleep state to the wake-up state. In this case, the communication device 10 enters the wake-up state for a relatively short time, and then transitions to the sleep state again. Therefore, if the wake-up state of the communication device 10 continues for a relatively long time, there is a high possibility that another device is performing communication at an abnormal timing. The communication monitoring unit 40 of the first embodiment can store, in the storage medium 30, communication information for specifying another device that has performed communication while the wake-up state of the communication device 10 continues. Therefore, the communication device 10 of the first embodiment can appropriately store communication information for specifying another device that performs communication at an abnormal timing regardless of the state of the communication device 10. A vehicle diagnostic apparatus can identify another device that has performed abnormal communication by using the communication information stored in the storage medium 30, and can analyze a failure that has occurred in the vehicle and an occurrence factor of the communication abnormality.

Furthermore, the communication device 10 of the first embodiment includes a system monitoring unit 50 that monitors a vehicle control system mounted on a vehicle. The timer 22 counts the duration of the wake-up state while the vehicle control system is in the stopped state. The communication monitoring unit 40 accumulates communication information while the vehicle control system is in the stopped state. When the duration of the wake-up state has passed a predetermined time, the communication monitoring unit 40 stores the communication information accumulated while the vehicle control system is in the stopped state in the storage medium 30.

As a result, the communication monitoring unit 40 according to the first embodiment can appropriately and reliably store, in the storage medium 30, communication information for specifying another device that has performed communication at an abnormal timing at which the vehicle control system continues to perform communication while being in the stopped state. Therefore, the communication device 10 of the first embodiment can appropriately and reliably store communication information for specifying another device that performs communication at an abnormal timing regardless of the state of the communication device 10. The vehicle diagnostic apparatus can reliably identify another device that has performed abnormal communication by using the communication information stored in the storage medium 30, and can reliably analyze a failure that has occurred in the vehicle and an occurrence factor of the communication abnormality.

Furthermore, the communication device 10 according to the first embodiment further includes an abnormality determination unit 60 that performs abnormality determination to determine whether another device has performed abnormal communication. The abnormality determination unit 60 performs the abnormality determination based on the execution frequency or the number of consecutive executions of the saving operation for storing the communication information accumulated while the vehicle control system is in the stopped state in storage medium 30.

As a result, the communication device 10 according to the first embodiment can accurately determine that communication performed at an abnormal timing at which communication continues while the vehicle control system is in the stopped state is abnormal. Therefore, the communication device 10 of the first embodiment can store communication information that can accurately specify another device that performs communication at an abnormal timing regardless of the state of the communication device 10. The vehicle diagnostic apparatus can accurately specify another device that has performed abnormal communication by using the communication information stored in the storage medium 30, and can accurately analyze a failure that has occurred in the vehicle and an occurrence factor of the communication abnormality.

Further, when determining that another device has performed abnormal communication, the abnormality determination unit 60 of the first embodiment notifies the occurrence of abnormality to the outside.

As a result, since the vehicle can quickly respond to the abnormal communication, it is possible to suppress occurrence of a serious trouble in the vehicle. For example, when abnormal communication is performed in a vehicle, power consumption may increase and battery exhaustion may occur. The vehicle equipped with the communication device 10 according to the first embodiment can respond quickly even if abnormal communication is performed, so that the possibility of battery exhaustion can be reduced.

### Second Embodiment

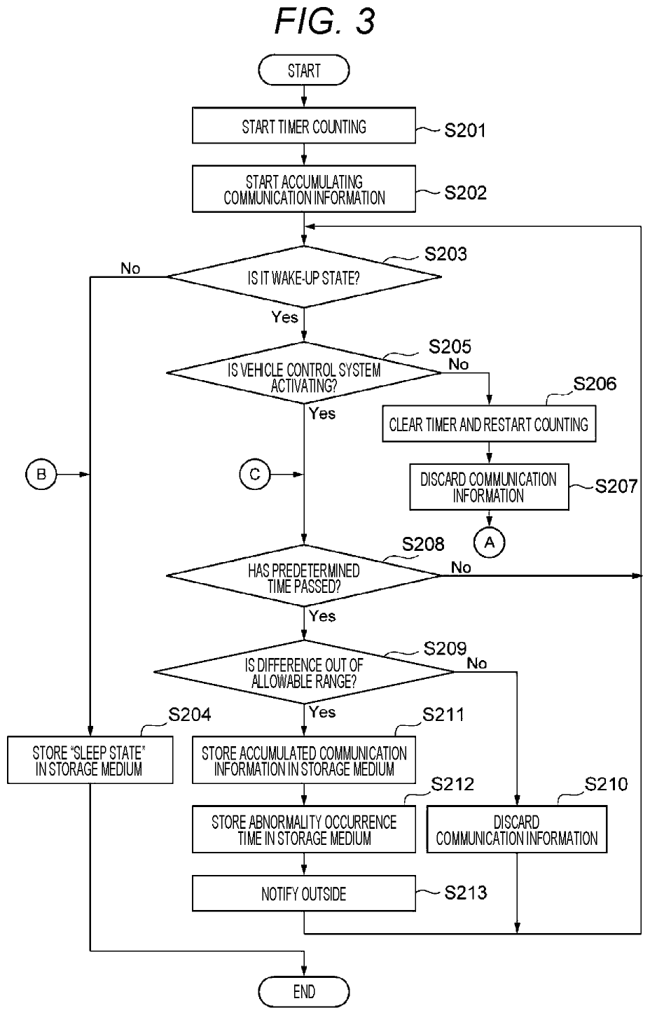

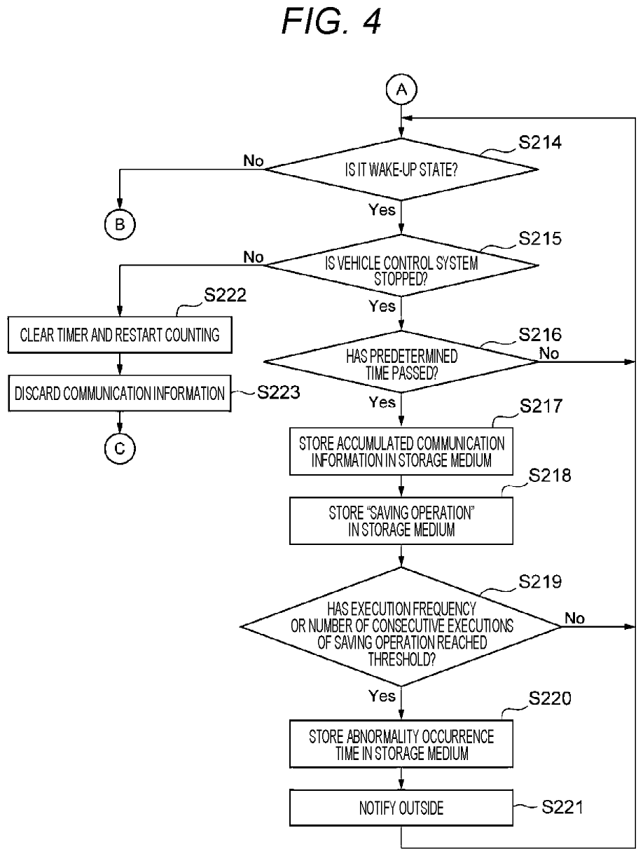

An communication device 10 according to a second embodiment will be described with reference to FIGS. 3 and 4. In the communication device 10 of the second embodiment, the description of the same configuration and operation as those of the first embodiment will be omitted.

The communication monitoring unit 40 of the first embodiment monitors communication with another device while the vehicle control system is in the stopped state, and stores communication information in the storage medium 30 when the other device performs abnormal communication. The communication monitoring unit 40 of the second embodiment monitors communication with another device not only while the vehicle control system is in the stopped state but also while the vehicle control system is in the activated state, and stores communication information in the storage medium 30 when the other device performs abnormal communication.

Information (hereinafter, also referred to as “teacher information”) regarding communication of another device acquired when the other device performs normal communication is preset in the communication monitoring unit 40 of the second embodiment. The information regarding communication includes identification information capable of identifying another device that performs communication, similarly to the communication information. Furthermore, the information regarding communication includes a communication channel with another device, a communication cycle of another device, an allowable time of a cycle deviation, and the like.

The communication monitoring unit 40 of the second embodiment accumulates communication information while the vehicle control system is in the activated state. The communication monitoring unit 40 of the second embodiment acquires information regarding communication of another device when the other device performs communication while the vehicle control system is in the activated state. The communication monitoring unit 40 of the second embodiment checks a difference between the information regarding communication and the teacher information. When the difference is out of the allowable range, the communication monitoring unit 40 of the second embodiment stores the communication information accumulated while the vehicle control system is in the activated state in the communication information storage area 32 of the storage medium 30. In a case where the difference is out of the allowable range, the communication monitoring unit 40 of the second embodiment determines that another device has performed abnormal communication. The communication monitoring unit 40 of the second embodiment stores the determined time as the abnormality occurrence time in the abnormality history storage area 36 of the storage medium 30.

FIG. 3 is a flowchart of processing performed by the communication device 10 according to the second embodiment. FIG. 4 is a flowchart of processing performed subsequent to the processing illustrated in FIG. 3. When transitioning to the wake-up state, the communication device 10 starts the process illustrated in FIG. 3.

In steps S201 to S204, the communication device 10 performs processes similar to those in steps S101 to S104. In step S205, the communication device 10 determines whether the vehicle control system is in the activated state. When determining that the vehicle control system is in the activated state, the communication device 10 proceeds to step S208. When determining that the vehicle control system is not in the activated state, the communication device 10 determines that the vehicle control system is in the stopped state, and proceeds to step S206.

In step S206, the communication device 10 clears the timer 22 and restarts counting.

In step S207, the communication device 10 discards the communication information accumulated in the accumulation area 42. Thereafter, the communication device 10 proceeds to step S214.

In step S208, the communication device 10 determines whether the time counted by the timer 22 has passed a predetermined time. In a case of determining that the time counted by the timer 22 has passed the predetermined time, the communication device 10 proceeds to step S209. In a case of determining that the time counted by the timer 22 has not exceeded the predetermined time, the communication device 10 proceeds to step S203.

In step S209, the communication device 10 determines whether the difference between the information regarding communication of the other device acquired when the other device performs the communication and the preset teacher information is out of the allowable range. In a case of determining that the difference is out of the allowable range, the communication device 10 proceeds to step S211. When determining that the difference falls within the allowable range, the communication device 10 proceeds to step S210.

In step S210, the communication device 10 discards the communication information accumulated in the accumulation area 42. Thereafter, the communication device 10 proceeds to step S203.

In step S211, the communication device 10 stores the communication information accumulated in the accumulation area 42 in the communication information storage area 32 of the storage medium 30. That is, the communication device 10 stores the communication information accumulated during the activated state of the vehicle control system in the communication information storage area 32 of the storage medium 30 when the difference between the teacher information and the information regarding communication of the other device acquired when the other device performs the communication while the vehicle control system is in the activated state is out of the allowable range.

In step S212, the communication device 10 stores a time stamp indicating the time at which the determination in step S209 is performed in the abnormality history storage area 36 of the storage medium 30 as the abnormality occurrence time. The communication device 10 may store a time stamp indicating the time at which the determination in step S208 is performed, that is, the time at which the time counted by the timer 22 has passed a predetermined time in the abnormality history storage area 36 of the storage medium 30 as the abnormality occurrence time.

In step S213, the communication device 10 notifies the occurrence of abnormality to the outside. Thereafter, the communication device 10 proceeds to step S203.

In steps S214 to S221, the communication device 10 performs processes similar to those in steps S103 and S105 to S111. However, when determining that the vehicle control system is not in the stopped state in step S215, the communication device 10 determines that the vehicle control system is in the activated state, and proceeds to step S222.

In step S222, the communication device 10 clears the timer 22 and restarts counting.

In step S223, the communication device 10 discards the communication information accumulated in the accumulation area 42. Thereafter, the communication device 10 proceeds to step S208.

Note that the communication device 10 discards the communication information accumulated in the accumulation area 42 in steps S207, S210, and S223, but may store the communication information in the storage medium 30 in a case where it is desired to store the communication information.

As described above, in the communication monitoring unit 40 of the second embodiment, teacher information that is information regarding communication of another device acquired when the other device performs normal communication is set in advance. The communication monitoring unit 40 accumulates communication information while the vehicle control system is in the activated state. The communication monitoring unit 40 stores the communication information accumulated while the vehicle control system is in the activated state in the storage medium 30 when the difference between the teacher information and the information regarding communication of the other device acquired when the other device performs the communication while the vehicle control system is in the activated state is out of the allowable range.

As a result, the communication monitoring unit 40 of the second embodiment can store the communication information accumulated not only while the vehicle control system is in the stopped state but also while the vehicle control system is in the activated state in the storage medium 30. Therefore, regardless of the state of the communication device 10, the communication device 10 of the second embodiment can store the communication information specifying another device that performs communication at an abnormal timing more comprehensively than the first embodiment. The vehicle diagnostic apparatus can specify, without omission, another device that has performed abnormal communication using the communication information stored in the storage medium 30, and can analyze, without omission, a failure that has occurred in the vehicle and an occurrence factor of the communication abnormality.

### Third Embodiment

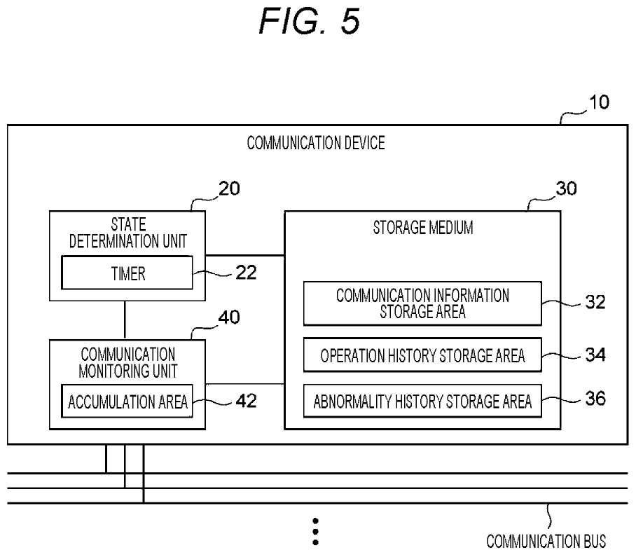

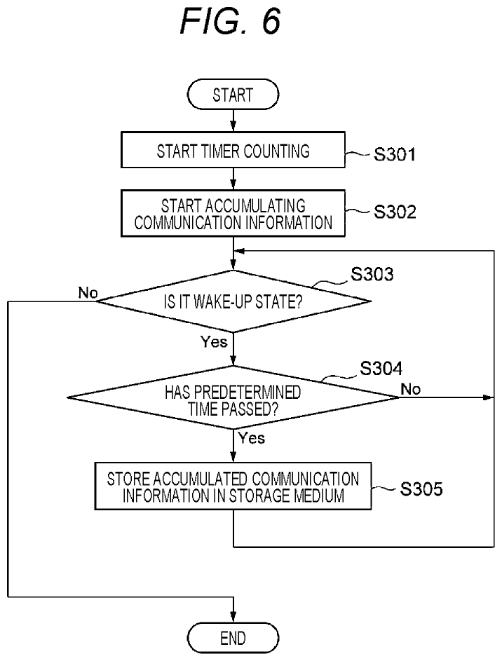

A communication device 10 according to a third embodiment will be described with reference to FIGS. 5 and 6. In the communication device 10 of the third embodiment, the description of the same configuration and operation as those of the first embodiment will be omitted.

FIG. 5 is a block diagram illustrating a functional configuration of the communication device 10 according to the third embodiment.

The communication monitoring unit 40 of the first and second embodiments monitors communication with another device, and stores communication information in the storage medium 30 when the other device performs abnormal communication. The communication monitoring unit 40 of the third embodiment monitors communication with another device, and stores communication information in the storage medium 30 when the duration of the wake-up state has passed a predetermined time regardless of whether the other device has performed abnormal communication.

As illustrated in FIG. 5, the communication device 10 according to the third embodiment can omit the system monitoring unit 50 and the abnormality determination unit 60 as compared with the first embodiment. The storage medium 30 according to the third embodiment may include the operation history storage area 34 and the abnormality history storage area 36 as illustrated in FIG. 5, but the operation history storage area 34 and the abnormality history storage area 36 can be omitted.

FIG. 6 is a flowchart of processing performed by the communication device 10 according to the third embodiment. When transitioning to the wake-up state, the communication device 10 starts the process illustrated in FIG. 6.

In steps S301 to S305, the communication device 10 performs processes similar to those in steps S101 to S103 and steps S106 to S107. However, in a case where it is determined in step S303 that the communication device 10 is not in the wake-up state, this process illustrated in FIG. 6 ends.

As described above, the communication monitoring unit 40 according to the third embodiment stores the communication information accumulated in the accumulation area 42 in the storage medium 30 when the duration of the wake-up state has exceeded a predetermined time regardless of whether another device has performed abnormal communication.

As a result, the communication device 10 according to the third embodiment can store the communication information specifying another device that performs communication at an abnormal timing more comprehensively than the first and second embodiments, regardless of the state of the communication device 10. The vehicle diagnostic apparatus can further completely specify another device that has performed abnormal communication by using the communication information stored in the storage medium 30, and can further completely analyze a failure that has occurred in the vehicle and an occurrence factor of the communication abnormality.

### [Others]

The present invention is not limited to the above embodiments, and various modifications may be contained. For example, the above-described embodiments of the present invention have been described in detail in a clearly understandable way, and are not necessarily limited to those having all the described configurations. In addition, some of the configurations of a certain embodiment may be replaced with the configurations of the other embodiments, and the configurations of the other embodiments may be added to the configurations of the subject embodiment. In addition, some of the configurations of each embodiment may be omitted, replaced with other configurations, and added to other configurations.

Each of the above configurations, functions, processing units, processing means, and the like may be partially or entirely achieved by hardware by, for example, designing by an integrated circuit. In addition, the configurations and the functions may be realized in software such that a processor analyzes and performs a program which realizes each function. Information such as a program, a tape, and a file for realizing each function can be stored in a recording device such as a memory, a hard disk, and a solid state drive (SSD), or a recording medium such as an IC card, an SD card, and a DVD.

In addition, only control lines and information lines considered to be necessary for explanation are illustrated, but not all the control lines and the information lines for a manufacture are illustrated. In practice, almost all the configurations may be considered to be connected to each other.

### REFERENCE SIGNS LIST

10 communication device
22 timer
30 storage medium
40 communication monitoring unit
50 system monitoring unit
60 abnormality determination unit

1. A communication device mounted on a vehicle and configured to communicate with another device, the communication device comprising:
a communication monitoring unit that monitors communication with the other device and accumulates communication information for specifying the other device that performs communication;
a storage medium that stores the communication information; and
a timer configured to count a duration of a wake-up state of the communication device,
wherein the communication monitoring unit stores the accumulated communication information in the storage medium when a duration of the wake-up state has passed a predetermined time.

2. The communication device according to claim 1, further comprising a system monitoring unit that monitors a state of a vehicle control system mounted on the vehicle,
wherein
the timer counts a duration of the wake-up state while the vehicle control system is in a stopped state, and
the communication monitoring unit is configured to:
accumulate the communication information while the vehicle control system is in a stopped state, and
store the communication information accumulated while the vehicle control system is in a stopped state in the storage medium when a duration of the wake-up state exceeds the predetermined time.

3. The communication device according to claim 2, further comprising an abnormality determination unit that performs an abnormality determination to determine whether the other device performs abnormal communication, wherein
the abnormality determination unit performs the abnormality determination based on an execution frequency or a number of consecutive executions of a saving operation for saving the communication information accumulated while the vehicle control system is in the stopped state in the storage medium.

4. The communication device according to claim 3, wherein when the abnormality determination unit determines that the other device has performed abnormal communication, the abnormality determination unit notifies an outside of occurrence of abnormality.

5. The communication device according to claim 2, wherein
teacher information that is information regarding communication of the other device acquired when the other device performs normal communication is preset in the communication monitoring unit, and
the communication monitoring unit is configured to:
accumulate the communication information while the vehicle control system is in an activated state, and
store, in the storage medium, the communication information accumulated while the vehicle control system is in an activated state when a difference between the teacher information and information regarding communication of the other device acquired when the other device performs communication while the vehicle control system is in the activated state is out of an allowable range.
